(19) United States
(12) Patent Application Publication
(10) Pub. No.: US 2019/0236512 A1
(43) Pub. Date: Aug. 1, 2019

(54) CAREER MANAGEMENT PLATFORMS

(71) Applicant: DiverseNote Enterprise LLC, Ypsilanti, MI (US)

(72) Inventor: Tekisha L. Lee, Ypsilanti, MI (US)

(21) Appl. No.: 16/242,956

(22) Filed: Jan. 8, 2019

Related U.S. Application Data
(60) Provisional application No. 62/622,742, filed on Jan. 26, 2018.
(60) Provisional application No. 62/614,759, filed on Jan. 8, 2018.

(51) Int. Cl. G06Q 10/06; G06F 16/242; G06F 16/2453; G06F 16/2457; G06Q 10/10

(52) U.S. Cl. CPC G06Q 10/063112; G06F 16/2425; G06Q 10/105; G06F 16/2457; G06F 16/2453

(57) ABSTRACT

An employee candidate search system and method is provided that enables a user to select certain qualification factors to emphasize and certain other qualification factors to deemphasize in a query to a database of candidates. The returned list of candidates reveals to the user the degree to which each candidate matched the totality of qualification factors but does not reveal to the user whether a particular candidate matched or did not match any specific qualification factor.

### CROSS-REFERENCE TO RELATED APPLICATIONS

This application claims the benefit of U.S. provisional application Ser. No. 62:614759, filed Jan. 8, 2018, and U.S. provisional application Ser. No. 62/622,742, filed Jan. 26, 2018, the disclosures of which are hereby incorporated in their entirety by reference herein.

### TECHNICAL FIELD

Certain embodiments of this disclosure relate to recruiting and hiring of employees based on employer-determined qualifications and/or diversity factors. More specifically, these embodiments relate to methods for searching a database of employee candidates and selecting a candidate that may satisfy the employer-determined qualification and/or diversity factors. Other embodiments of this disclosure relate to career plan management for employment candidates. More specifically, these embodiments relate to methods for using relevant employment management plans to guide employment candidates toward their career goals.

### BACKGROUND

There are systems that may search a database and return elements of the database based on those searches in the employment candidate-search context. Some of these systems allow a user to search based on a plurality of criteria, returning a list of candidates that indicates how many of the criteria each candidate matched, for example by percentage. These systems may equally emphasize all criteria in the search operation. These systems may not be capable of weighing criteria differently, for example deemphasizing certain criteria and/or emphasizing certain criteria.

Some of these systems may not effectively mask from the user the specific criteria that a given candidate matched or did not match, which may contribute to subconscious bias. These systems may fail to detect and/or mitigate subconscious bias.

### SUMMARY

Certain embodiments of this disclosure may allow a user to search a database of employee candidates and compile results based on those searches. The database may comprise employee candidate profiles each created by an employee candidate. The profile may comprise a plurality of employee-identified qualifications, for example educational credentials or number of years of work experience, and employee-identified diversity factors, for example race or gender of the candidate. The term criteria may be used hereafter to describe a set of qualifications and/or diversity factors. Hereafter the terms criterion, qualification, qualification factor, and factor may be used interchangeably.

The criteria may comprise emphasized criteria and deemphasized criteria. The system may return at least one list of employee candidate profiles. Hereafter a returned employee candidate profile may simply be called a candidate when in the context of a database or database search result. At least one list may contain a plurality of high-matching candidates, some of which may have matched to a given deemphasized criterion and some of which may not have matched to that deemphasized criterion.

The disclosed technology may assist employers with identifying career candidates who are likely to meet certain qualification factors that employers may desire or may wish to emphasize in their workforce. In one embodiment, a system is disclosed for searching a database of employee candidate profiles and processing the results based on qualification factors input by the user. Such a system allows for the results to be parsed to deemphasize one or more qualification factors while emphasizing one or more other qualification factors. In one embodiment, the deemphasized qualification factor is related to diversity, in which an employer may search for potential employees while taking diversity into account but without violating discrimination laws and regulations.

In one embodiment, the system includes an employer end-user portal configured to input search criteria and receive the results dataset related to that search. In such a system, a database module may include a career candidate portal configured to put in self-identifying qualification factors, including factors to be deemphasized, and a processor that generates a database of career candidates from the self-identified factors.

In one embodiment, a processing module may compare the search criteria to the candidate database to generate a full results list which is then categorized into subsets that either include or exclude the deemphasized qualification factor. In such a system, these subsets may then be parsed into at least one list of results that include a mix of career candidates selected separately based on search criteria either including or excluding the deemphasized qualification factor and at least one list that contains all career candidates who meet a significant portion of all qualification factors, including both the deemphasized factor and the emphasized factor.

In one embodiment, a non-transitory computer readable medium having instructions stored thereon that when executed by a processor cause the processor to perform operations of, responsive to input selecting a subset of criteria describing desired diversity and employment qualifications from a list of predefined criteria describing possible diversity and employment qualifications, identifying, from a database having candidate employees indexed against diversity and employment characteristics, candidates having diversity and employment characteristics that satisfy one or more of the subset, ordering a list of the candidates according to a number of diversity and employment characteristics that satisfy the one or more of the subset, and presenting the list without indicating which diversity and employment characteristics were among the diversity and employment characteristics that satisfied the one or more of the subset.

Certain embodiments of this disclosure may lead an employment candidate to create a set of career goals based on the candidate's answers to a set of questions provided by the disclosure. One embodiment will recognize content in the goals and create a career management plan for the candidate. In the follow-up, the embodiment will track the candidate's response to the recommendations in the career management plan and adapt the management plan to guide the candidate toward the final career goals.

### BRIEF DESCRIPTION OF THE DRAWINGS

FIG. 1 schematically illustrates a computer code system for employment searches.

FIG. 2 schematically illustrates an employer module of the system of FIG. 1.

FIG. 3 schematically illustrates a database module of the system of FIG. 1.

FIG. 4 schematically illustrates a processing module of the system of FIG. 1.

FIG. 5 schematically illustrates the categorization tool of the processing module of FIG. 4.

FIG. 6 schematically illustrates the deemphasized factor module of the categorization tool of FIG. 5.

FIG. 7 schematically illustrates the emphasized factor module of the categorization tool of FIG. 5.

FIG. 8 schematically illustrates the parsing tool of the categorization tool of FIG. 5.

FIG. 9 schematically illustrates one algorithm for modifying pre-released datasets.

FIG. 10 schematically illustrates a second algorithm for modifying pre-released datasets.

FIG. 11 schematically illustrates an algorithm for attempting initiation of factor frequency modification.

FIG. 12 schematically illustrates an algorithm for modifying factor frequency.

FIG. 13 schematically illustrates a second algorithm for modifying factor frequency.

FIG. 14 schematically illustrates the systems work flow process.

FIG. 15 schematically illustrates a computer system interface for an employment candidate to set career goals.

### DETAILED DESCRIPTION

Various embodiments of the present disclosure are described herein. However, the disclosed embodiments are merely exemplary and other embodiments may take various and alternative forms that are not explicitly illustrated or described. The figures are not necessarily to scale; some features may be exaggerated or minimized to show details of particular components. Therefore, specific structural and functional details disclosed herein are not to be interpreted as limiting, but merely as a representative basis for teaching one of ordinary skill in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. However, various combinations and modifications of the features consistent with the teachings of this disclosure may be desired for particular applications or implementations.

All systems and all modules may be hosted on one server. Alternatively, certain systems or modules may be hosted on one server that does not host other systems or modules. Alternatively, each system and each module may be hosted on multiple servers in a single network or may be distributed over a network. Each of the repositories and databases disclosed herein may be implemented using proprietary databases or standard database software, and each database may be hosted locally, distributed over a network, or hosted remotely, such as on the cloud. These repositories and databases may be periodically updated either automatically or manually.

The following numerals are used to identify the corresponding elements in the figures for the several embodiments. 200-level numbers refer to elements of or associated with the employer module; 300-level numbers refer to elements of or associated with the database module; 400-level numbers refer to elements of or associated with the processing module; 500-level numbers refer to elements of or associated with the deemphasized factor module; 600-level numbers refer to elements of or associated with the emphasized factor module; 700-level numbers refer to elements of or associated with the parsing tool, and so on.
100 system
200 employer module
201 user device
202 employer end-user portal
204 search criteria selection tool
206 search generator
300 database module
301 user device
302 candidate end-user portal
304 factor input tool
306 deemphasized factor
308 emphasized factor
310 factor input processor
312 candidate database
400 processing module
402 search data receiver
404 candidate database comparison tool
406 full results generator
408 categorization tool
410 top results generator
412 result dataset generator
416 top results generator
500 deemphasized factor module
502 high percentage isolation tool
504 randomized selector
506 subset A generator
508 subset B generator
600 emphasized factor module
602 deemphasized factor removal tool
604 high percentage isolation tool
606 subset C generator
700 parsing tool
702 exclusion tool
704 inclusion tool
900 dataset algorithm
1000 dataset algorithm
1100 factor frequency modification initiation attempt algorithm
1200 factor frequency algorithm
1300 factor frequency algorithm
1400 work flow process
1500 candidate portal interface

One embodiment of the system monitors the pre-released dataset, the gathered data before it is released to the employer. If the pre-released dataset contains less than a predetermined emphasized threshold of candidate employees, the pre-released dataset may be modified before being released to the employer. Upon reception of a modified released dataset, the employer may be notified of the modification.

One method of modification of the pre-released dataset includes adding candidate employees that have at least one employer selected deemphasized factor and at least one non-selected emphasized factor in the dataset, until the predetermined emphasized threshold of candidate employees has been reached. Application of this method of modifying the pre-released dataset is shown in the following example. If a pre-released dataset comprising 90 candidate employees is generated with an emphasized factor of female, a deemphasized factor of 15 years of manufacturing experience, and a predetermined emphasized threshold of 50%, yet contains 40 female candidate employees and 50 non-emphasized candidate employees, modification of the dataset may be needed to meet the predetermined emphasized threshold, since 40 candidate employees that have emphasized factors is less than 50% of 90 total candidate employees. To meet this threshold, 10 employee candidates that have the at least one deemphasized factor, 15 years of manufacturing experience, and at least one non-selected emphasized factor, such as military veteran, may be added to the pre-released dataset, increasing the total of candidate employees with at least one emphasized factor to 50, and the total candidate employees of the pre-released dataset to 100. Since this will result in the dataset containing at least 50% of candidates of an emphasized factor, which for this example is the predetermined emphasized threshold, the modified dataset may be released (e.g., output for viewing by the requestor).

Another method of modification of the pre-released dataset includes creating a modified deemphasized factor by modifying the parameters of the at least one deemphasized factor for use in generating the pre-released dataset, followed by adding candidate employees that have the modified deemphasized factor and the at least one selected emphasized factor. This method of modification can be repeated with the modified deemphasized factor being further modified until the pre-released dataset meets the predetermined emphasized threshold, or until a set number of iterations have passed. Application of this method of modifying the pre-released dataset is seen in the following example. If a pre-released dataset comprising 90 candidate employees is generated with an emphasized factor of female, a deemphasized factor of 15 years of manufacturing experience, and a predetermined emphasized threshold of 50%, yet contains 40 female candidate employees and 50 non-emphasized candidate employees, modification of the dataset may be needed to meet the predetermined emphasized threshold, since 40 candidate employees that have emphasized factors is less than 50% of 90 total candidate employees. To meet the predetermined emphasized threshold, parameters of the deemphasized factor may be modified from 15 to 10 years of manufacturing experience. Newly discovered female candidate employees may now be added to the pre-released dataset. If the newly discovered female candidate employees added to the pre-released dataset increase the total female candidate employees to at least 50% of the pre-released dataset, the dataset may be released. If the additional newly discovered female candidate employees do not increase the total female candidate employees to at least 50% of the pre-released dataset, modification of the parameters of the deemphasized factor may be repeated until the total amount of female candidate employees are at least 50% of the pre-released dataset. Upon the pre-released dataset containing at least 50% of candidates of emphasized factors, the dataset may be released.

Another method of modification of the pre-released dataset includes removing candidate employees that do not have an emphasized factor from the dataset. Application of this method of modifying the result of a pre-released dataset is seen in the following example. If a pre-released dataset comprising 1100 candidate employees was generated with a female emphasized factor, a deemphasized factor of 15 years of manufacturing experience, and a predetermined emphasized threshold of 50%, yet contains 500 female candidate employees and 600 non-emphasized candidate employees, modification of the pre-released dataset may be needed to meet the predetermined emphasized threshold, since 500 candidate employees is less than 50% of 1100 total candidate employees. To meet the predetermined emphasized threshold, 100 candidate employees that do not have an emphasized threshold may be removed from dataset, resulting in a total of 500 female candidate employees in a dataset of 1000 candidate employees. Since this will result in the dataset containing at least 50% of candidates of emphasized factors, the dataset may be released.

The predetermined emphasized threshold may be one or a combination of a fixed amount, fixed percentage, variable amount, and variable percentage. A predetermined emphasized threshold of variable percentage may be based on parameters including the selection of the employer's profile type, wherein the employers EEOC requirements may be determined through the employer's profile type.

One embodiment of the system monitors a factor frequency, which may be comprised of the total occurrences (e.g., 12 occurrences) of at least one selected emphasized factor (e.g., veteran) contained in at least one employer generated dataset generated in a response to a job posting query (e.g., 100 candidate employees pulled from a bank of 1000 platform users, yielding a factor frequency of 12%). Note that if 100 out of 1000 platform users identify as veteran, the frequency factor for veteran relative to the platform of users is 10%. In contrast, a factor frequency may be comprised of the total occurrences of at least one selected emphasized factor contained in a series of datasets, including the series of all datasets. The factor frequency may be measured in percentage, ratio, sum, and other numerical metrics. If the factor frequency is not equal to or greater than a first predetermined frequency threshold, the factor frequency may be increased upon future employer generated pre-released datasets. If the factor frequency is not equal to or less than a second predetermined frequency threshold, the factor frequency may be decreased upon future employer generated pre-released datasets. This embodiment may contain a target factor frequency, comprised of a value equal to or greater than the first predetermined frequency threshold, and equal to or less than the second predetermined frequency threshold. This target frequency may be the average of first and second predetermined frequency thresholds.

One method of modifying the factor frequency includes assigning a variable value, a priority parameter, to the emphasized factors. In one example, the weighting in which one of several parameters is assigned may be changed. If veterans are underrepresented in the candidate employee pre-released data set (e.g., being less than 5% of the identified candidates while the threshold is 10%), the weightings associated with those users of the bank that identify as veteran may be altered (e.g. the weighting assigned emphasized and/or non-emphasized factors when matching users to job postings may be changed). If the job posting requires 15 years of experience, and this yields candidates only 5% of which are veterans, the years of experience requirement may be automatically relaxed (e.g., to 10 years) only for those in the bank identifying as veteran. As such, relative to other users that do not identify as veteran, presumably the number of candidates in the pre-released data set identifying as veteran should increase once the matching is performed again. Other modifications to the weighting of parameters are contemplated and can be used. Continuing with the previous example, if those with 15 years of experience are given a weighting score of 90, and those with 10 to 15 years of experience are given a weighting score of 60, and those with 0 to 10 years of experience are given a weighting score of 20 (in which those with the highest rating scores are selected for a job posting requiring 15 years of experience), the system may add bonus weighting score points to veterans to increase their overall score and thus factor frequency in the pre-released data set.

In the above example, the threshold was set at 10%, but could be any suitable number. It may be predetermined or be based on the factor frequency for a demographic or group of the bank of users. For example, if 50% of the platform users identify as female, the threshold could be established such that the above automatic modifications are triggered if the factor frequency in pre-released data (data pulled in response to job postings) for females is less than 25%. That is, weighting parameters for those identified as female could be altered such that at least 25% of candidate employees in pre-released data sets identify as female. This, of course, can be extrapolated to multiple factors (e.g., veteran and disabled, etc.) Single factors were used to facilitate ease of explanation. Once the factor frequencies for the represented groups or factors are at or above their corresponding thresholds, the data may be released (output) for viewing by those posting the jobs in certain embodiments. The data may also be released even if the represented groups or factors are not at or above their corresponding thresholds.

The variable value may be used to compare the priority of occurrence in datasets for candidates of emphasized factors. The value differential, the amount the variable value may be adjusted, may be dependent upon previous experienced change, the differential of the factor frequency and the predetermined frequency threshold. One method of calculating the variable differential is to look at the effect to factor frequency from a previous application of variable differential. Application of this method to calculate the value differential is shown in the following example. If the current factor frequency is 10%, the previous factor frequency was 6%, the target factor frequency is 8%, the current variable value is 3, and the previous variable value was 1, giving a previously applied variable differential of 2 (absolute value of previous variable value subtracted from current variable value), the current method would take into account that an application of a variable differential of 2 increased the factor frequency by 4%, a ratio of 1:2. Therefore, to reduce the current factor frequency of 10% to 8%, a value differential of 1 may be applied. If there is no previously applied variable differential, a fixed ratio may be used.

If higher value grading is assigned to higher frequency in datasets related to the search, a request to increase the factor frequency would increase the variable value of the at least one selected emphasized factor, and a request to decrease the factor frequency would decrease the variable value. If higher value grading is assigned to lower frequency in populating query results, a request to increase the factor frequency would decrease the variable value of the at least one selected emphasized factor, and a request to decrease the factor frequency would increase the variable value. Application of this method of modifying the factor frequency is shown in the following example. If a first predetermined frequency threshold for the veteran emphasized factor is 6%, the assigned variable value of the veteran emphasized group is 1, and higher value grading is assigned to higher frequency in datasets, yet a series of datasets show a factor frequency of 3%, modification of the factor frequency may be needed to raise it to the threshold value of 6%. Raising the variable value of the veteran emphasized factor from 1 to 2 would give the veteran emphasized factor greater priority in being added to following employer generated datasets. Greater priority may allow the at least one selected emphasized factor to increase its frequency of being contained in employer generated datasets, therefore, increasing the factor frequency. Similarly, if a second predetermined frequency threshold for the veteran emphasized factor is 9%, the assigned variable value to the veteran emphasized factor is 2, and higher value grading is assigned to higher frequency in datasets, yet a series of datasets show a factor frequency of 10%, modification of the factor frequency may be needed to lower it to the threshold value of 9%. Lowering the variable value of the veteran emphasized factor from 2 to 1.5 would give the veteran emphasized factor lower priority in being added to the following employer generated datasets. Lower priority may allow the at least one selected emphasized factor to decrease its frequency of being contained in employer generated datasets, therefor, decrease the factor frequency.

Another method of modifying the factor frequency includes assigning a modified deemphasized factor protocol to the at least one selected emphasized factor, by modifying the parameters of the at least one deemphasized factor for the at least one selected emphasis factor when an employer requests a new dataset. This protocol may assign a protocol score, a priority parameter, a value to control the amount of modification to deemphasized factors, to emphasized factors under the protocol. One method of determining the protocol score would be to look at the effect to the factor frequency from a previous modification of the protocol score. Application of this method to determine the protocol score is shown in the following example. If the current factor frequency is 10%, the previous factor frequency was 6%, the target factor frequency is 8%, the current protocol score is 3, and the previous protocol score was 1, the current method would take into account the previous change in protocol score of 2 that increased the factor frequency by 4%, a ratio of 1:2. Therefore, to reduce the current factor frequency of 10% to 8%, the protocol score may be modified by 1. If the emphasized factor is not currently on modified deemphasized factor protocol, a fixed ratio may be used.

Application of modified deemphasized factor protocol modifying the factor frequency is shown in the following example. If a first predetermined frequency threshold for the veteran emphasized factor is 6%, yet a series of dataset results show a factor frequency of 3%, modification of the factor frequency may be changed to raise it to the threshold value of 6%. To modify this factor frequency, a modified deemphasized factor protocol with a protocol score of 1 may be assigned to the veteran emphasized factor. Following this protocol assignment, if an employer requests a dataset comprising the female emphasized factor, and the deemphasized factor of 15 years of manufacturing experience, the parameters of the deemphasized factor of 15 years manufacturing experience may be modified to 10 years manufacturing experience for candidate employees that have the veteran emphasized factor. In this situation, a veteran female with 10 years manufacturing experience may share the same priority as a non-veteran female with 15 years manufacturing experience for this dataset. If dataset monitoring shows that after modified deemphasized factor protocol has been assigned, the factor frequency still has not reached the desired target, the parameters of the protocol may be further modified to increase factor frequency. Application of this method of further modifying the factor frequency is shown in the following example. If a first predetermined frequency threshold for the veteran emphasized factor is 6%, and the veteran emphasized factor is currently under modified deemphasized factor protocol with a protocol score of 1, yet a series of dataset results show a factor frequency of 4%, the protocol score of the veteran emphasized threshold may be increased to 2. Following this protocol score increase, if an employer requests a dataset comprising the female emphasized factor, and the deemphasized factor of 15 years of manufacturing experience, the parameters of the deemphasized factor of 15 years manufacturing experience may be modified to S years manufacturing experience for candidate employees that have the veteran factor. In this situation, a veteran female with 5 years manufacturing experience may share the same priority as a non-veteran female with 15 years manufacturing experience for this dataset. If, however, a first predetermined frequency threshold for the veteran emphasized factor is 6%, and the veteran emphasized factor is currently under modified deemphasized factor protocol with a protocol score of 2, yet a series of dataset results show a factor frequency of 8%, the protocol score of the veteran emphasized threshold may be decreased to 1.5. Following this protocol score decrease, if an employer requests a dataset comprising the female emphasized factor, and the deemphasized factor of 15 years of manufacturing experience, the parameters of the deemphasized factor of 15 years manufacturing experience may be modified to 7.5 years manufacturing experience for candidate employees that have the veteran factor. In this situation, a veteran female, with 7.5 years manufacturing experience may share the same priority as a non-veteran female with 15 years manufacturing experience for this dataset.

One method of attempting initiation of factor frequency modification may be based on at least one of a predetermined time interval, and a predetermined trigger event. This is an attempted initiation as if the factor frequency is equal to or greater than a first predetermined frequency threshold and the factor frequency is equal to or less than a second predetermined frequency threshold, the factor frequency may not need to be modified. Application of these methods of initiating a factor frequency modification attempt is shown in the following examples. If a predetermined time interval is used, and the predetermined time interval is 1 month, and a month has elapsed from the last factor frequency modification initiation attempt, the system may compare the factor frequency to at least one of the first predetermined frequency threshold, and the second predetermined frequency threshold. If the factor frequency is equal to or greater than a first predetermined frequency threshold, and equal to or less than a second predetermined frequency threshold, the time interval may be reset without factor frequency modification. If a trigger event is used, and the trigger event is set to start when the factor frequency is equal to or greater than twice the value of a second predetermined frequency threshold, the event of the factor frequency rising equal to or greater than twice the value of the second predetermined frequency threshold may initiate a factor frequency modification attempt. If a combination of a predetermined time interval and a trigger event is used, with the predetermined time interval set to 1 month, and the trigger event is set to start when the factor frequency is equal to or greater than twice the value of a second predetermined frequency threshold, a factor frequency modification attempt may occur when at least one of, the factor frequency is equal to or greater than twice the value of a second predetermined frequency threshold, or one month has elapsed from the last factor frequency modification attempt, including those started by the event triggers.

The first and second predetermined frequency thresholds may be one or a combination of fixed rate, fixed percentage, variable rate, and variable percentage. A predetermined frequency threshold of variable percentage may be based on the amount of candidate employees that have the at least one selected emphasized factor compared to sums including, the amount of candidate employees that do not have the at least one selected emphasized factor and all candidate employees. A predetermined frequency threshold of variable percentage may be based on the amount of people that have at least one selected emphasized factor compared to groups including all local population, and global population.

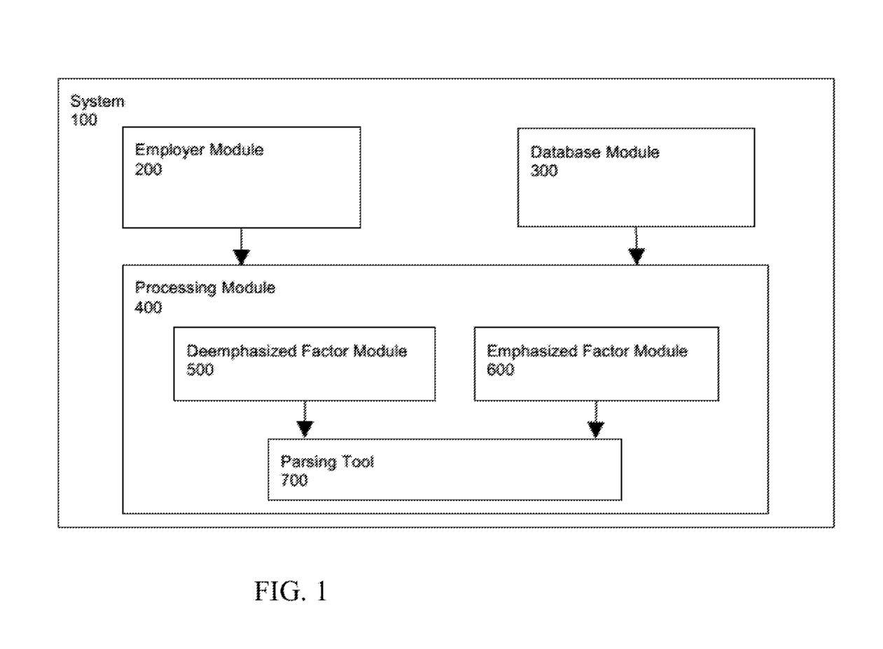

FIG. 1 schematically shows a high-level view of one embodiment of the system 100. In an exemplary embodiment, the system 100 includes an employer module 200, a database module 300, and a processing module 400. The processing module 400 in turn includes a deemphasized factor module 500, an emphasized factor module 600, and a parsing tool 700.

The employer module 200 is configured to receive search criteria and generate a code that can be compared to a database containing corresponding searchable data. The employer module 200 may include any device, now known or later discovered, capable of converting user inputs into a machine-readable format.

The database module 300 is configured to receive information from individual users related to predetermined personal and professional characteristics, to convert the information into a machine-readable code, and to compile and process that code to produce a searchable database.

The database module 300 may include any device, now known or later discovered, capable of converting user inputs into a machine-readable format.

The processing module 400 is configured to receive the search data generated by the employer module 200, compare it to the database generated by the database module 300, and categorize the results of that comparison to generate a result data set that can be viewed by the user. The categorization function of the processing module 400 is accomplished by running the comparison results through both the deemphasized factor module 500 and the emphasized factor module 600 and then generating different lists of results using the parsing tool 700.

The deemphasized factor module 500 is configured to isolate the information available through the database module 300 that is most comparable to the search information available through the employer module 200 and to separate the results into subsets.

The emphasized factor module 600 is configured to isolate the information available through the database module 300 excluding those criteria designated as deemphasized that is most comparable to the search information available through the employer module 200 and to create an additional subset.

The parsing tool 700 then distributes the subsets generated by the deemphasized factor module 500 and the subset generated by the emphasized factor module 600 into lists of results that are viewable by a user.

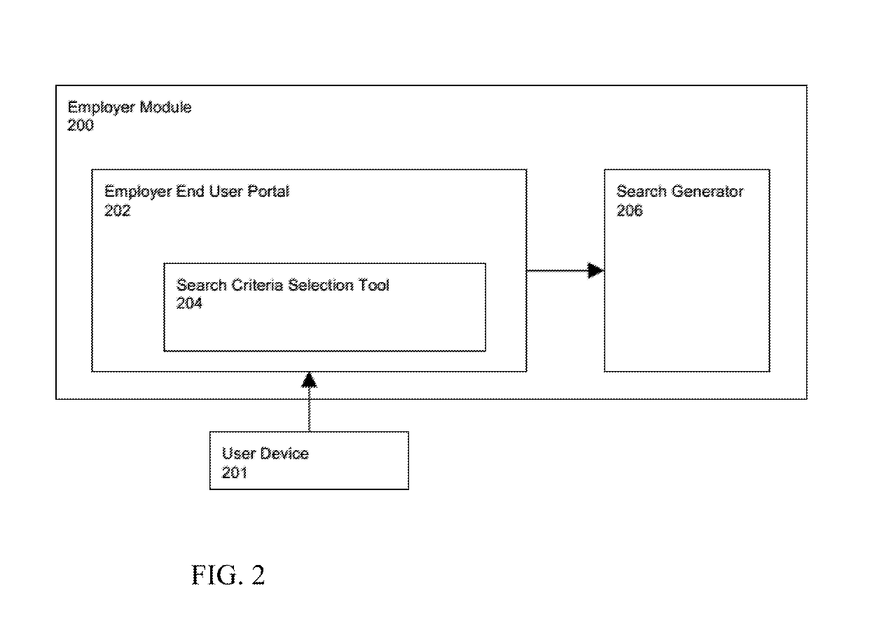

FIG. 2 schematically shows a high-level view of an employer module 200. In an exemplary embodiment, the employer module 200 includes an employer end-user portal 202 and a search generator 206. The employer end-user portal 202 may also encompass a search criteria selection tool 204. The employer end-user portal 202 is designed to receive inputs from users regarding desired qualifications of potential career candidates, including inputs made using the search criteria selection tool 204.

The search criteria selection tool 204 functions to allow users to select qualification factors from a list of such factors. The employer end-user portal 202 may be accessible by a user via a user device 201, which may be any device or collection of devices that can receive user inputs and translate the inputs into machine-readable code. For example, user the device 201 may be a smart phone or personal computer in the possession of a user. The user device 201 communicates user inputs to the search generator 206 via the employer end-user portal 202.

The search generator 206 is configured to receive the machine-readable code versions of user inputs and to compile the resulting data in a format that may allow it to be compared to the content of a database. The employer end-user portal 202 and the search generator 206 may exist on either the same or separate devices. However, the employer end-user portal 202 and the search generator 206 may exist on the same device. They may be connected to each other via a network.

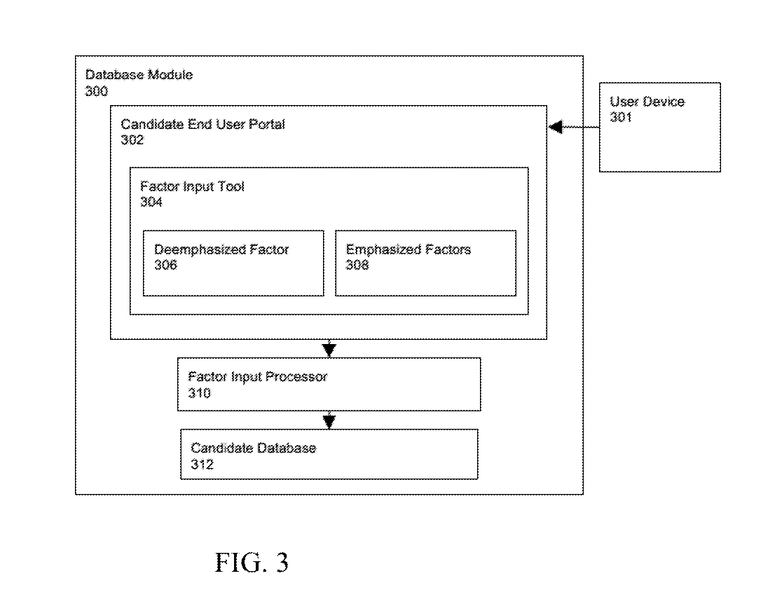

FIG. 3 schematically shows a high-level view of a database module 300. In an exemplary embodiment, the database module 300 includes a candidate end-user portal 302, a factor input processor 310, and a candidate database 312. The candidate end-user portal 302 in turn includes a factor input tool 304 which encompasses at least one deemphasized factor 306 and a plurality of emphasized factors, here represented by emphasized factors 308.

The deemphasized factor 306 may be, for example, an employment qualification factor such as race, gender, or sexual orientation that contributes to diversity in the workplace but that cannot be a basis for hiring under applicable laws or regulations. The emphasized factors 308 may include, for example, employment qualification factors that are legally permissible hiring criteria such as experience in a relevant field of employment or applicable skills. In other examples, the deemphasized factor 306 may be employment qualification factors that are legally permissible hiring criteria such as experience in a relevant field of employment or applicable skills. And the emphasized factors 308 may include an employment qualification factor such as race, gender, or sexual orientation that contributes to diversity in the workplace but that cannot be a basis for hiring under applicable laws or regulations.

The candidate end-user portal 302 is designed to receive inputs from users regarding individual users' professional and/or personal employment qualification factors. Particular user inputs are categorized as either a deemphasized factor 306 or as one of several emphasized factors 308. This may be carried out via a factor input tool 304 which may but need not include a list of factors from which users may select factors that apply to said users. Factors included on this list may be categorized as a deemphasized factor 306 or may be categorized as one of several emphasized factors 308.

The candidate end-user portal 302 may be accessible by a user via a user device 301, which may be any device or collection of devices that can receive user inputs and translate the inputs into machine-readable code. For example, the user device 301 may be a smart phone or personal computer in the possession of a user. The user device 301 communicates user inputs to the factor input processor 310 via the candidate end-user portal 302.

The factor input processor 310 is configured to receive the machine-readable code versions of user inputs and to compile the resulting data into data subsets corresponding to the categorization of given datum according to the factor input tool 304 as a deemphasized factor 306 or as one of several emphasized factors 308. The factor input processor 310 compiles the data subsets into a candidate database 312 against which searches, such as those compiled by the search generator 206, may be performed. The candidate end-user portal 302, factor input processor 310, and candidate database 312 may exist on either the same or separate devices. They may be connected to one another via a network.

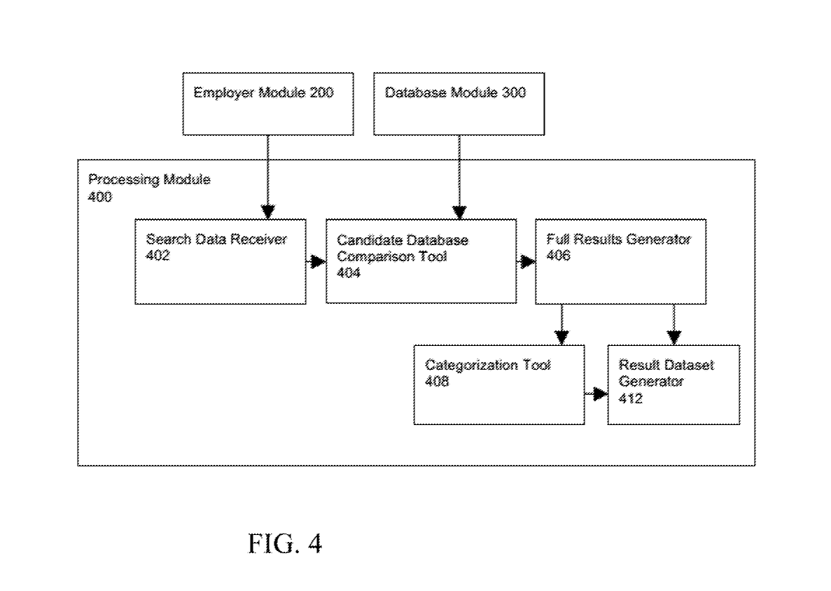

FIG. 4 schematically shows a high-level view of a processing module 400. In an exemplary embodiment, the processing module 400 includes a search data receiver 402, a candidate database comparison tool 404, a results generator 406, a categorization tool 408, and a result dataset generator 412. The search data receiver 402 functions to receive the output of the employer module 200, specifically the search generator 206 (as shown in FIG. 2).

The search data receiver 402 communicates employer search data to the candidate database comparison tool 404. The candidate database comparison tool 404 receives employer search data from the search data receiver 402 and receives the candidate database 312 (as shown in FIG. 3) from the database module 300. The candidate database comparison tool 404 compares the data received from each such module and identifies matches based on degree of similarity between the totality of the search terms compiled by the search generator 206 and the totality of qualification factors associated with a particular individual career candidate accounted for in the candidate database 312.

The data from the candidate database comparison tool 404 is analyzed by the full results generator 406, which compiles a more traditional dataset of results that does not distinguish between deemphasized factors and emphasized factors. The categorization tool 408 receives the output of the full results generator 406. The categorization tool 408 analyzes and categorizes such output to determine what matches between data from the employer module 200 and data from the database module 300 will be included in at least one final results dataset. This data is received by result the dataset generator 412 which compiles at least one set of results that accounts for the difference between deemphasized factors and emphasized factors. This dataset may be viewed by the user.

The result dataset generator 412 may also receive the full output of the full results generator 406 and may generate an additional result dataset that does not distinguish between deemphasized factors and emphasized factors that may be viewable by the user.

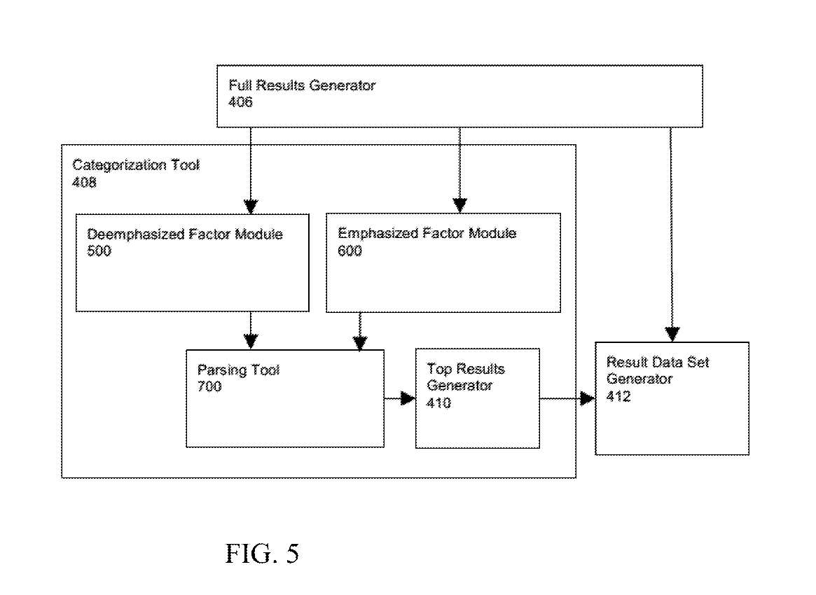

FIG. 5 shows an embodiment of the categorization tool 408. In this exemplary embodiment, the categorization tool 408 includes a deemphasized factor module 500, an emphasized factor module 600, a parsing tool 700, and a top results generator 410.

The categorization tool 408 functions to receive and categorize the output of the full results generator 406. The deemphasized factor module 500 receives the data output of the full results generator 406 and categorizes the data output of the full results generator 406 into a plurality of subsets which are in turn communicated to the parsing tool 700. The emphasized factor module 600 receives the data output of the full results generator 406, re-processes the data to effectively remove those with the deemphasized factor from the search results and re-categorize the results into a subset.

The data subsets of the deemphasized factor module 500 and the data subset of the emphasized factor module 600 are then received by the parsing tool 700. The parsing tool 700 determines which subsets will be included in the final results and then sends those subsets to the result dataset generator 412 to be compiled into the final results.

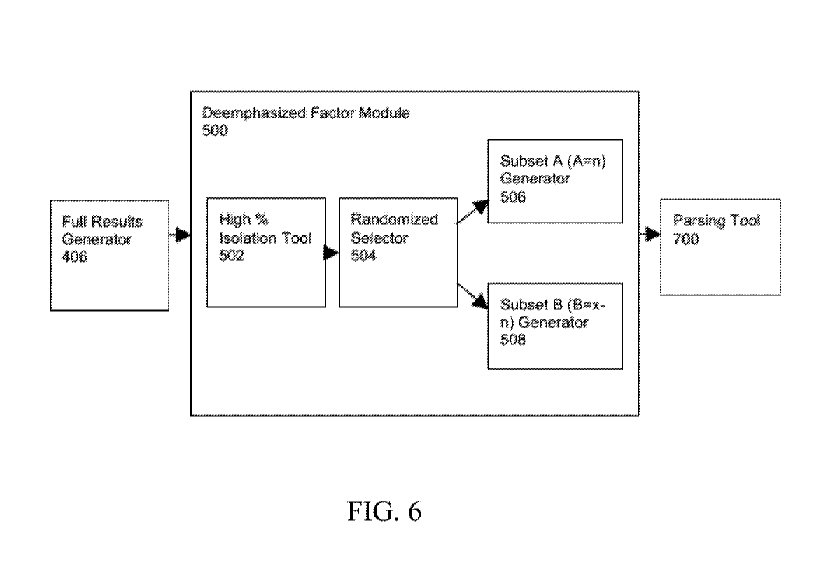

FIG. 6 shows an embodiment of a deemphasized factor module 500 of the categorization tool 408. In this exemplary embodiment, the deemphasized factor module 500 includes a high percentage isolation tool 502, a randomized selector 504, a subset A generator 506, and a subset B generator 508. The deemphasized factor module 500 is configured to receive the data output of the full results generator 408 and process that data for inclusion in the final results viewable by the user.

The high percentage isolation tool 502 functions to identify and isolate a predetermined number of data points from the data output of the full results generator 408, those isolated data points tending to show the highest relative degree of correlation between the search output of the employer module 200 and the database output of the database module 300.

The resulting isolated data is then sent to and received by the randomized selector 504. The randomized selector 504 provides each data point with a random identifier and sends the data to the subset A generator 506 and the subset B generator 508. The subset A generator 506 creates a data subset A which comprises a number of data points equal to n. The subset B generator 508 creates a data subset B which comprises a number of data points equal to the total number of isolated data points generated by the high percentage isolation tool 502 minus n, i.e., all isolated data points not included in data subset A created by the subset A generator 506. Data subset A and data subset B are then communicated to the parsing tool 700 for further processing.

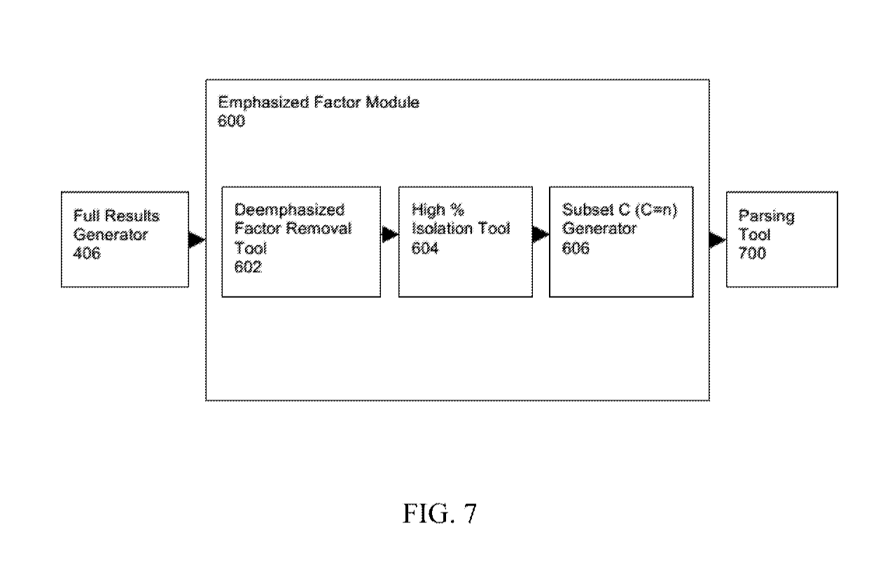

FIG. 7 shows an embodiment of an emphasized factor module 600 of the categorization tool 408. In this exemplary embodiment, the emphasized factor module 600 includes a deemphasized factor removal tool 602, a high percentage isolation tool 604, and a subset C generator 606. The emphasized factor module 600 is configured to receive the data output of the full results generator 408, effectively eliminating the effect of the deemphasized factor being included in the search selection tool 204 of the employer module 200 on that data, and processing the data for inclusion in the final results viewable by the user.

The deemphasized factor removal tool 602 functions to re-categorize the data generated by full the results generator 408 to remove any reference within the results data to the identified deemphasized factor. For example, the deemphasized factor removal tool 602 may function by deleting those portions of the data produced by the full results generator 408 that describe the deemphasized factor. The re-categorized data is then sent to and received by the high percentage isolation tool 604.

The high percentage isolation tool 604 functions to identify and isolate a predetermined number of data points from the data output of the full results generator 408, those isolated data points tending to show the highest relative degree of correlation between the search output of the employer module 200 and the database output of the database module 300, excluding the effect of the deemphasized factor. The resulting isolated data is then sent to and received by the subset C generator 606. The subset C generator 606 creates a data subset C which comprises a number of data points equal to n. Data subset C is communicated to the parsing tool 700 for further processing.

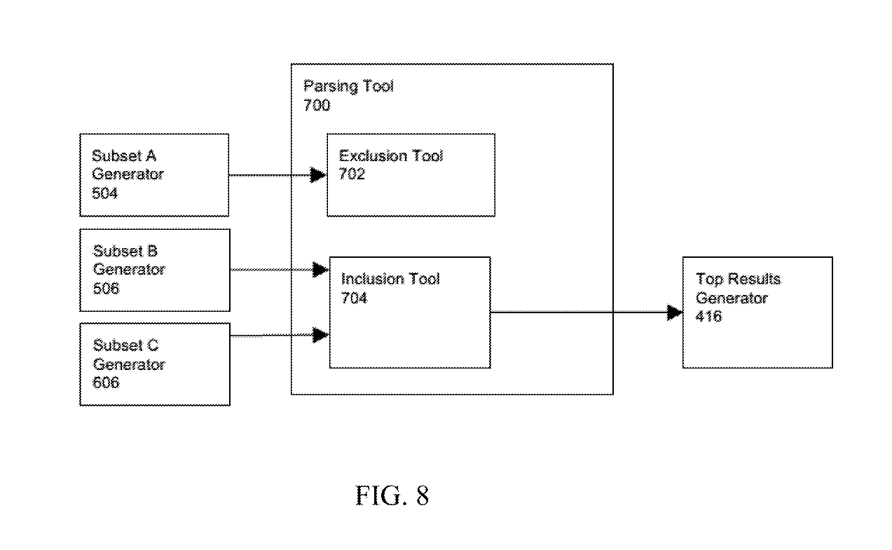

FIG. 8 shows an embodiment of a parsing tool 700 of the categorization tool 408. In this exemplary embodiment, the parsing tool 700 includes an exclusion tool 702 and an inclusion tool 704. The exclusion tool 702 receives data subset A created by the subset A generator 504. The inclusion tool 704 receives data subset B created by the subset B generator 506 and data subset C created by the subset C generator 606.

Data subset B and data subset C, the data subsets received by the inclusion tool 704, are sent to and received by the top results generator 412. The top results generator 412 compiles the data subset B and data subset C into a list of highly correlative matches between the search output of the employer module 200 and the database output of the database module 300 that is viewable by the user.

The viewable list generated by the top results generator 412 may indicate and display emphasized factors shared by the search and the database results. The viewable list generated by the top results generator 412 does not indicate or display deemphasized factors. The viewable list generated by the top results generator 412 may, but need not, be ordered from the match demonstrating the greatest degree of correlation between the search output of the employer module 200 and the database output of the database module 300 to the match demonstrating the lowest degree of such correlation.

The exclusion tool 702 excludes data categorized into data subset A from inclusion in the list of highly correlative matches generated by the top results generator 412, but the exclusion tool 702 does not necessarily exclude data categorized into data subset A from inclusion in top results dataset generator 412.

In one embodiment, prior to the input of search criteria into the employer end-user portal 202, the employer end-user enters log-in data associated with a particular employer account. In one embodiment, the employer end-user portal 202 will receive the associated information upon the input of search criteria and create an associated record of factors users of the employer account have included in searches over time. This record may be used to adjust the categorization of factors as either emphasized or deemphasized in later searches by that employer end-user.

In one embodiment, the past search record may be generated as part of the employer module 200. For example, the past search record may be generated within the employer end-user portal 202 and communicated to search the search data receiver 402 with other employer search data from the employer module 200. Alternatively, the past search record may constitute a separate module within the employer module 200 which communicates with the search generator 206 before the employer module 200 data is communicated to the search data receiver 402.

Thus, particular embodiments of the subject matter have been described in this specification. In some cases, the actions recited herein can be performed in a different order and still achieve desirable results. Additionally, the processes depicted in the accompanying figures do not necessarily require the particular order shown, or any sequential order, to achieve desirable results. In some implementations, multitasking and parallel processing may be preferable or advantageous.

All systems may be hosted on one server. Alternatively, certain systems may be hosted on one server that does not host other systems. Alternatively, each system may be hosted on multiple servers in a single network or may be distributed over a network. Each of the repositories and databases disclosed herein may be implemented using proprietary databases or standard database software, and each database may be hosted locally, distributed over a network, or hosted remotely, such as on the cloud. These repositories and databases may be periodically updated either automatically or manually.

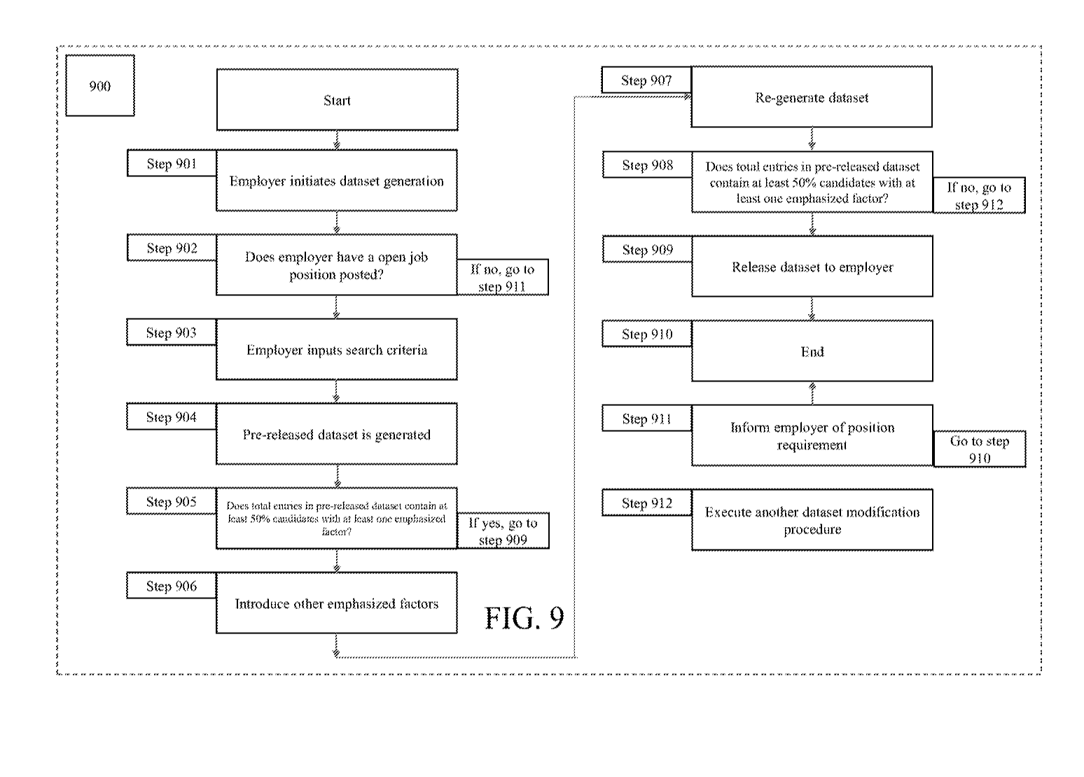

FIG. 9-FIG. 13 disclose algorithms that may be executed by a processor. Processing module (400) is capable of processing said algorithms.

FIG. 9 shows an algorithm for modifying an employer generated dataset. In step 901, the employer begins the modification process by starting a request for a dataset from the database. In step 902, the system may ensure that the employer has a current open career position posted on the portal. If the employer does not have an open position posted, the algorithm moves to step 911, which informs the employer that an open career position needs to be posted before generation of a dataset and proceeds to end the algorithm. If the employer does have an open career position posted, the method will move to step 903. In step 903, the employer inputs the desired search criteria, comprising at least one deemphasized factor. In some instances, an emphasized factor may be included based on the employer account type. In step 904, the system takes the search criteria, and generates a dataset to be analyzed before release to the employer. In step 905, the algorithm analyzes the pre-released dataset, checking to ensure that the emphasized candidates are equal to or above a predetermined emphasized threshold. In this embodiment, the threshold is 50% of the total candidates of the pre-released dataset. However, the predetermined emphasized threshold is not required to be 50%, and can vary with each employer, population set, emphasized factor, and other variables. If the pre-released dataset does contain at least 50% or above emphasized candidates, the method jumps to step 909, releasing the dataset to the employer. If, however, the dataset is not comprised of at least 50% emphasized candidates, the algorithm moves to step 906. In step 906, the algorithm introduces the emphasized factors into the search that may not have been included in the initial dataset generation. In step 907, the algorithm regenerates the dataset with the original factors and the newly introduced emphasized factors from step 906. Similar to step 905, in step 908, the algorithm analyzes the new pre-released dataset, checking to ensure that the dataset is comprised of at least 50% emphasized candidates. If the dataset is comprised of at least 50% emphasized candidates, the algorithm moves to step 909, release the dataset to the employer, followed by moving to step 910, ending the process. If, however, the pre-released dataset is still comprised of less than 500/% emphasized candidates, the algorithm moves to step 912, informing the system to try a different method of dataset modification. In an alternate embodiment, the algorithm may choose to terminate if step 907 does not produce a dataset comprised of at least 50% candidate employees.

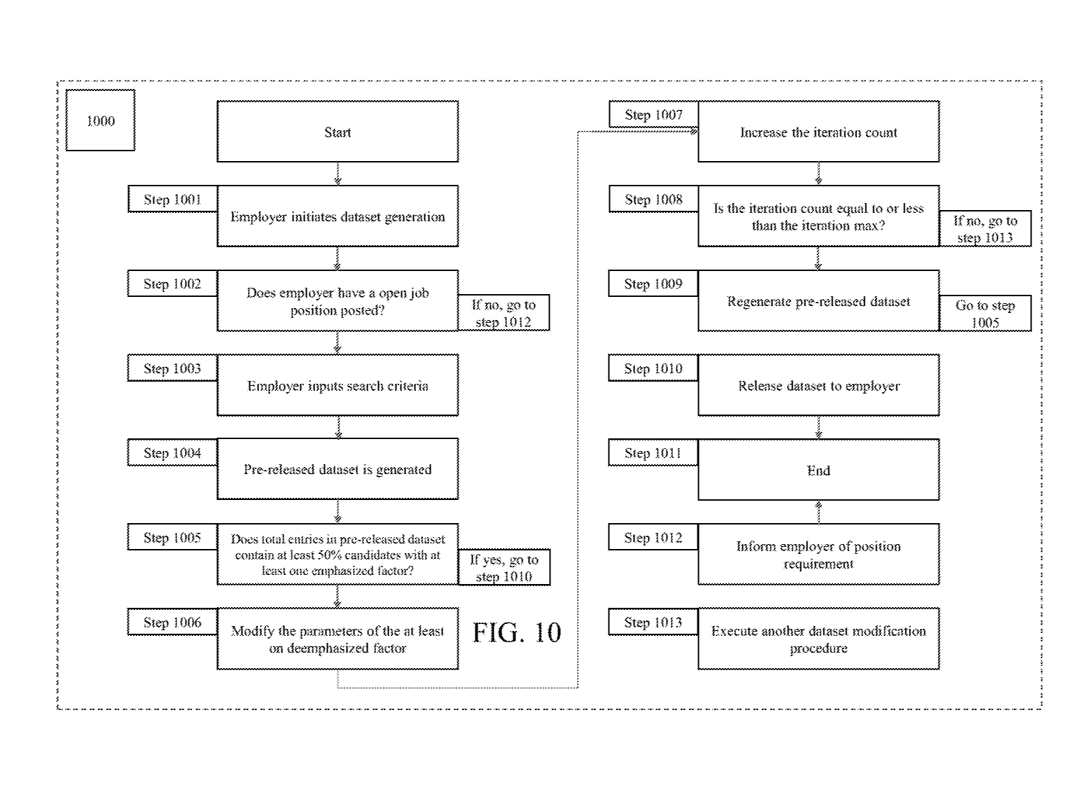

FIG. 10 shows a second algorithm for modifying an employer generated dataset. In step 1001, the employer begins the modification process by starting a request for a dataset from the database. In step 1002, the system may ensure that the employer has a current open career position posted on the portal. If the employer does not have an open position posted, the algorithm moves to step 1012, which informs the employer that an open career position needs to be posted before generation of a dataset and proceeds to end the algorithm. If the employer does have an open career position posted, the method will move to step 1003. In step 1003, the employer inputs the desired search criteria, comprising at least one deemphasized factor. In some instances, an emphasized factor may be included based on the employer account type. In step 1004, the system takes the search criteria, and generates a dataset to be analyzed before release to the employer. In step 1005, the algorithm analyzes the pre-released dataset, checking to ensure that the emphasized candidates are equal to or above a predetermined emphasized threshold. In this embodiment, the threshold is 50% of the total candidates of the pre-released dataset. However, the predetermined emphasized threshold is not required to be 50%, and can vary with each employer, population set, emphasized factor, and other variables. If the pre-released dataset does contain at least 50% or above emphasized candidates, the method jumps to step 1010, releasing the dataset to the employer, followed by moving to step 1011, ending the process. If, however, the dataset is not comprised of at least 50% emphasized candidates, the algorithm moves to step 1006. In step 1006, the algorithm modifies the parameters of at least one of the previously searched deemphasized factors, to include more candidates in the search results. In step 1007, the algorithm increases the iteration count for the search. In 1008, the algorithm compares the current iteration count to the allowed iterations. If the iteration counter is greater than the allowed iterations, the algorithm moves to step 1013, requesting the system to attempt a different dataset modification procedure. In an alternate embodiment, the algorithm may choose to terminate if the iteration counter is greater than the allowed iterations. If the iteration counter is equal to or less than the allowed iterations, the algorithm moves to step 1009. In step 1009, the algorithm regenerates the pre-released dataset with modified parameters of the deemphasized factor, then returns to step 1005.

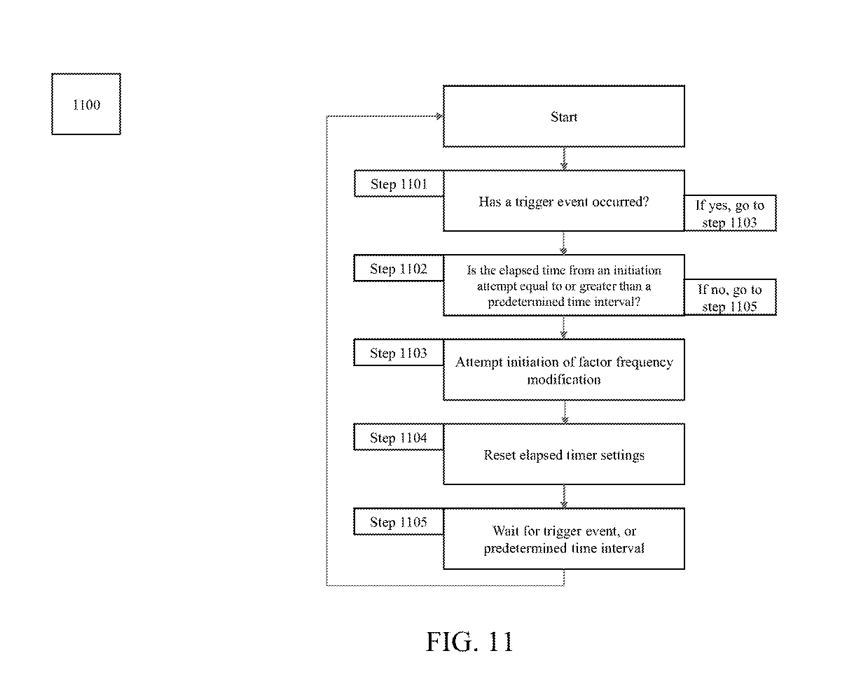

FIG. 11 shows an algorithm for initiating an attempt to modify factor frequency. In step 1101, the algorithm monitors the system for a trigger event. This trigger event may serve as a wake up for the factor frequency modification initiation system and may comprise of a routine to monitor current factor frequency to predetermined frequency threshold values. If a trigger event has occurred the algorithm will move to step 1103 and attempt to initiate factor frequency modification. If a trigger event has not occurred, the algorithm will move to step 1102. In step 1102, the algorithm may compare the elapsed time from an initiation attempt, to a predetermined time interval. If the time elapsed is less than the predetermined time interval, the algorithm will move to step 1105, and wait for a trigger event or predetermined time interval to elapse. If, however, the time elapsed is at least the same as the predetermined time interval, the algorithm will move to step 1103 and attempt to initiate factor frequency modification. In step 1104, the algorithm will reset the elapsed timer.

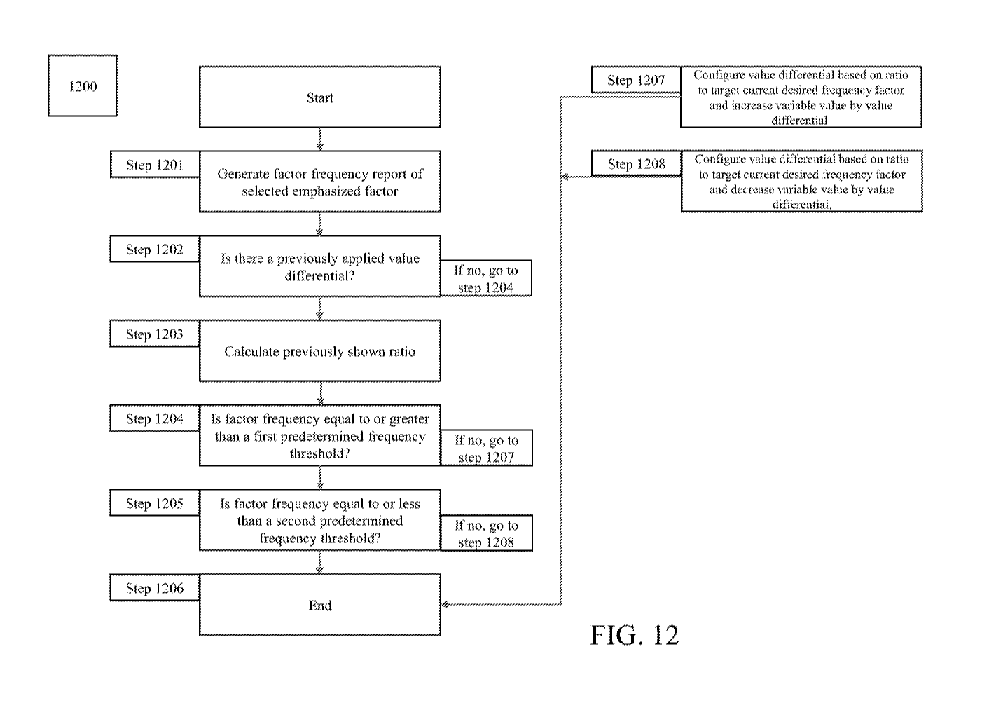

FIG. 12 shows an algorithm for modifying factor frequency. In step 1201, the algorithm generates a factor frequency report comprised of total occurrences of at least one emphasized factor in at least one pre-released dataset. A factor frequency report may be comprised of the total occurrences of multiple emphasized factors in a series of datasheets. In step 1202, the algorithm checks the previously applied value differential used in previous factor frequency modification. If there is no previously applied value differential, a fixed number may be uses as the value differential, and the algorithm moves to step 1204. If a value differential has be previously applied, the algorithm moves to step 1203. In step 1203, the algorithm calculates the ratio of the effect the previous value differential and the difference in factor frequency. In step 1204, the algorithm compares the current factor frequency to a first predetermined frequency threshold. If the current factor frequency is less than a first predetermined frequency threshold, the algorithm moves to step 1207, which increases the variable value with the ratio calculated in step 1203, followed by moving to step 1206, ending the process. If the current factor frequency is at least the same value as the first predetermined frequency threshold, the algorithm moves to step 1205. In step 1205, the algorithm compares the current factor frequency to a second predetermined frequency threshold. If the current factor frequency is greater than a second predetermined frequency threshold, the algorithm moves to step 1208, which decreases the variable value with the ratio calculated in step 1203, followed by moving to step 1206, ending the process. If the current factor frequency is at most the same value as the second predetermined frequency threshold, the algorithm moves to step 1206, ending the process.

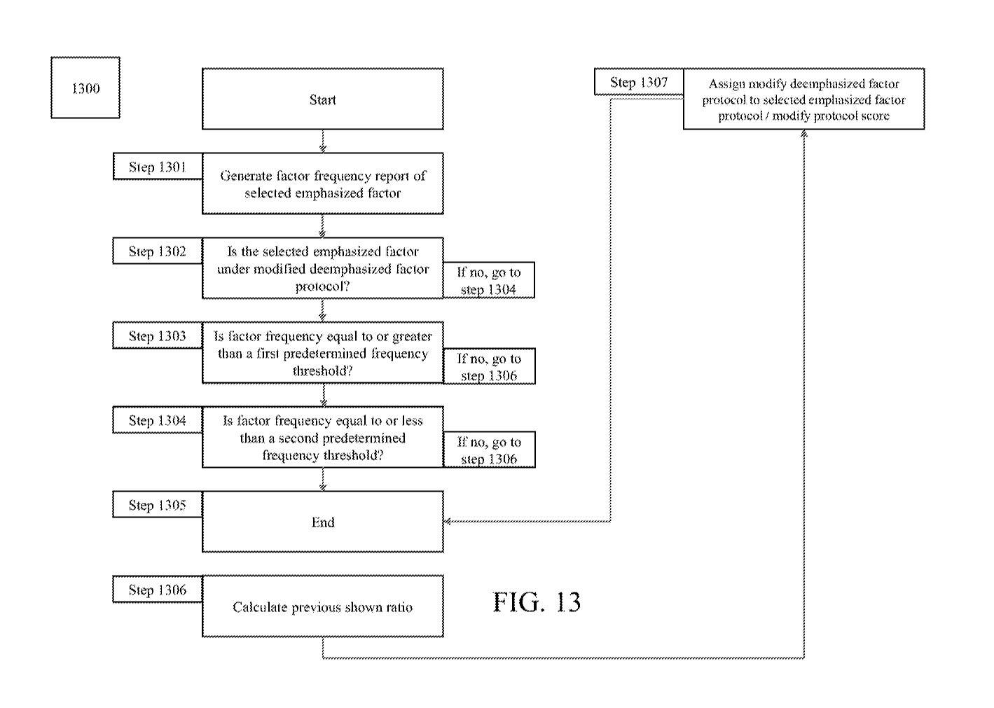

FIG. 13 shows a second algorithm for modifying factor frequency. In step 1301, the algorithm generates a factor frequency report comprised of total occurrences of at least one emphasized factor in at least one pre-released dataset. A factor frequency report may be comprised of the total occurrences of multiple emphasized factors in a series of datasheets. In step 1302, the algorithm checks if the selected emphasized factor is currently under modified deemphasized factor protocol. If the emphasized factor is not under protocol, the algorithm moves step 1304. However, if the emphasized factor is under protocol the algorithm moves to step 1303. In step 1303, the algorithm compares the factor frequency to a first predetermined frequency threshold. If the current factor frequency is not at least the value of the first predetermined frequency threshold, the algorithm moves to step 1306. If the current factor frequency is at least the value of the first predetermined frequency threshold, the algorithm moves to step 1304. In step 1304, the algorithm compares the factor frequency to a second predetermined frequency threshold. If the current factor frequency is not at most the value of the second predetermined frequency threshold, the algorithm moves to step 1306. If the current frequency is at most the value of the second predetermined frequency threshold, the algorithm moves to step 1305, ending the process. In step 1306, the algorithm calculates the ratio of the effect the previous adjustment in protocol score and difference in factor frequency. In step 1307, the algorithm may assign a modified deemphasized factor protocol to a previously unassigned emphasized factor. The algorithm may also modify the protocol score with the ratio calculated in step 1306.

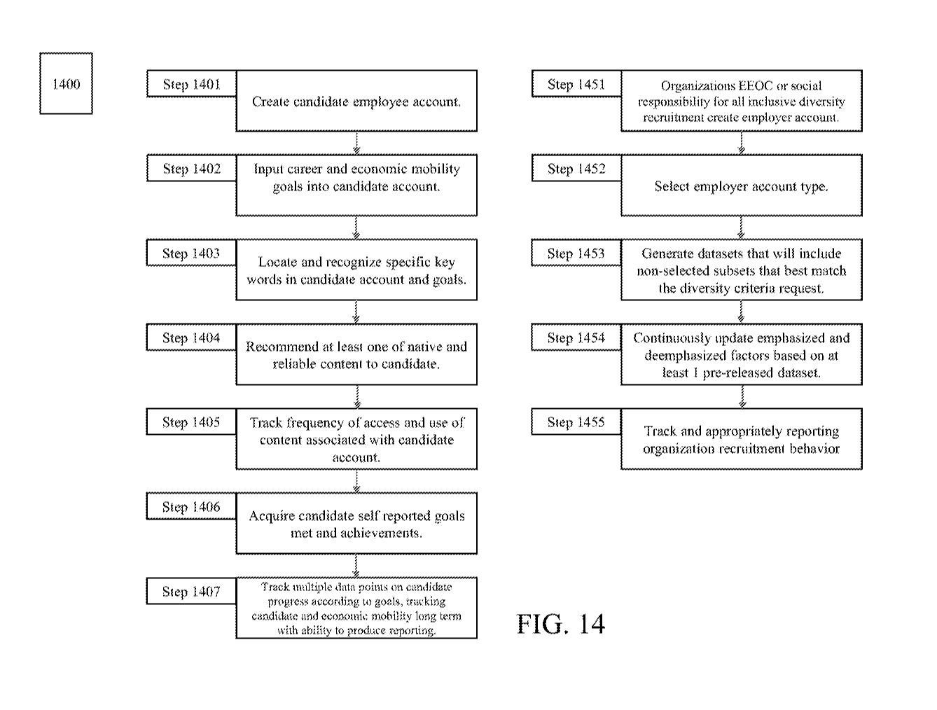

FIG. 14 shows work flow process of the candidate employee and the employer. Steps 1401-1407 correspond to the candidate employee work flow process. In step 1401, the potential candidate may create a candidate account, including indicating values for emphasized and deemphasized factors. If the candidate does not select or indicate an emphasized or deemphasized factor, a value of 0 may be assigned. If a user has 15 years of experience, they may assign a value of 15 years to the work experience deemphasized factor. Other deemphasized factors, such as “programming experience” or “management experience,” may also be assigned values according to known techniques. Natural language descriptions may be considered values for purposes herein. Put a different way, values need not be input by users as numbers per se. Known techniques, for example, can be used to determine that “software programmer” is a better match for the deemphasized factor of “programming experience” as compared with “software manager.” Likewise, known techniques can be used to determine that “software manager” is a better match for the deemphasized factor of “programming experience” as compared with “school teacher.” Given that computers store and process data as numbers, “programming experience” thus has a “value” as a deemphasized factor in certain embodiments. If a user identifies as a veteran, a value of 1 may be assigned to the veteran emphasized factor. If a user identifies as a male, a value of 0 may be assigned to the female emphasized factor, etc.

In step 1402, the candidate may input the career and mobility goals into the account created in step 1401. In step 1403, the system may locate key words throughout the candidate account. In step 1404, the system may recommend the candidate native and reliable content based on the key words located in step 1404. In step 1405, the system may monitor and track access and use of the content delivered to the candidate in step 1405. In step 1406, the system may monitor the candidate's account for updates regarding new goals and accomplishments. In step 1407, the system may produce reporting based on the candidate's progression. Steps 1451-1454 correspond to the employer's work flow process.

In step 1451, organizations, including those with legal obligations, such as EEOC obligations, and social responsibility for all inclusive diversity recruitment may create an employer profile. In step 1452, the employer may associate an account type with their profile. Account types may include government organizations, government contractor, and non-government contractors. In step 1453, the employer may generate datasets that may include non-selected subsets that best match the diversity criteria requested. In some embodiments, the diversity criteria may be associated with the account type selected in step 1452. In step 1454, the system may continuously update emphasized and deemphasized factor status based on results including at least one pre-released dataset. In step 1455, the system may track and appropriately report organization recruitment behavior.

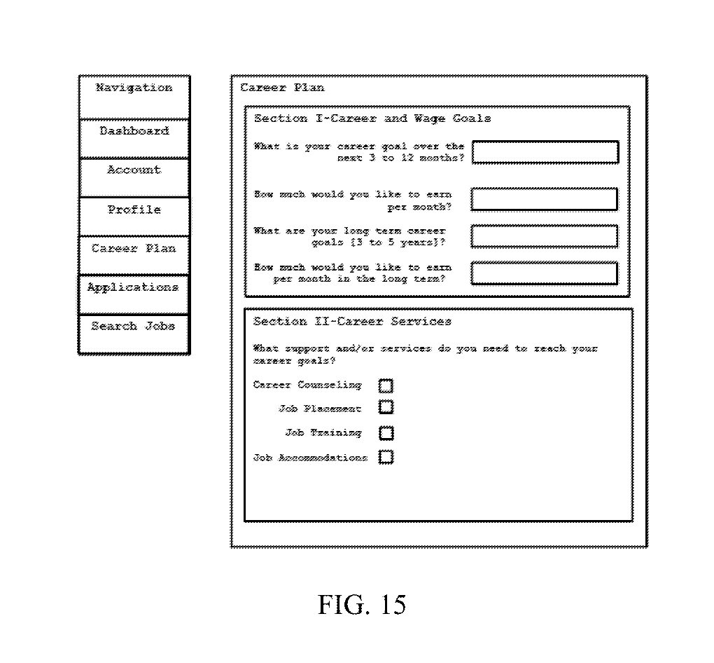

FIG. 15 schematically shows a computer interface for an employment candidate to set career goals so that the disclosure can create a career management plan for the candidate. In an exemplary embodiment, the interface includes navigation control buttons on the left including Dashboard, Account, Profile, Career Plan, Application and Search Jobs functions which are arranged in a vertical manner. An employment candidate could click through these buttons to access the individual functions in the interface. The right side of the interface is a list of questions and selections which may allow the creation of a career management plan for the candidate. The two sections on the right side of the interface are labeled Career and Wage Goals and Career Services alternatively. The employment candidate may provide answers to these questions and make selections based on individual career goals.

In addition to the questions in the career plan in FIG. 15, the system may also ask the employment candidate for three milestones that may help the candidate reach the ultimate goal. The system may ask the employment candidate these questions on either an annual or quarterly basis.

Then the system recognizes key words in the employment candidate's career plan, for example, highest level of education, industry, geography and what their career and educational goals are.

After the goals and milestones are recorded by the system for an employment candidate, the system recognizes content in the milestones. Then the system searches for content on the Internet using the extracted key words and recommends best practice articles for careers within the industry of the employment candidate. In addition, the system has a listing of every single company per industry in its database. The system also recommends articles and videos for how to prepare for a job interview as a candidate.

These recommendations are made for example daily, weekly or twice per month, depending on the candidate's preference for alerts. There is a filter in the system that helps to reduce the number of articles returned. An automated filter sends no more than 4 articles per day and a candidate can change the settings to receive once per week. Once the candidate has opted to click on or select the recommendations, the recommendations selected (such as URL links, title, and goal they are for) are documented in a candidate career plan. Once the Internet link of the content is clicked by the candidate, a log is created to inform the system that the candidate has viewed the content. If the candidate never clicked on anything, they get a reminder email too.

If the candidate has not selected any of the recommendations. Weekly, the system asks the candidate if they have achieved their career goal. If the candidate says yes, the system sends the candidate a congratulations email. If the candidate says no, the system recognizes that the candidate did not reach a specific goal. Then, the system reminds the candidate of the helpful recommendations in their career plan and also recommends additional relevant content for that goal. The system also documents that the goal for the specific quarter is not achieved.

Embodiments of the subject matter and operations described in this specification can be implemented in digital electronic circuitry or in computer software, firmware, or hardware, including the structures disclosed in this specification and their structural equivalents, or in combinations of one or more of them.

Embodiments of the subject matter described in this specification can be implemented as one or more computer programs, i.e., one or more modules of computer program instructions, encoded on one or more computer storage medium for execution by or to control the operation of a data processing apparatus, such as a processing circuit. An exemplary processing circuit such as a CPU may comprise any digital or analog circuit components configured to perform the functions described in this specification, such as a microprocessor, microcontroller, application-specific integrated circuit, programmable logic, or some other component or components.

Alternatively or in addition, the program instructions can be encoded on an artificially-generated propagated signal, for example, a machine-generated electrical, optical, or electromagnetic signal, that is generated to encode information for transmission to suitable receiver apparatus for execution by a data processing apparatus.

While this specification contains many specific implementation details, there should not be construed as limitations of the scope of this disclosure or of what may be claimed. Rather, they are descriptions of features specific to particular embodiments. Some features that are described in the context of separate embodiments in this specification may also be implemented in combination in a single embodiment. Conversely, various features described in the context of a single embodiment may be implemented separately in multiple embodiments or in any suitable sub-combination. Additionally, although certain features may be described above as acting in certain combinations and even initially claimed as such, one or more features from a particular claimed combination can in some cases be removed from the combination, and the claimed combination may be directed to a sub-combination or variation thereof.

Similarly, while operations may be depicted in the drawings as taking place in a particular order, this should not be understood as requiring such operations be performed in the particular order shown or in sequential order to achieve desirable results. In some circumstances, multitasking and parallel processing may be preferable or otherwise advantageous. Likewise, the order of operations depicted in the drawings should not be understood as requiring that all illustrated operations be performed.

The separation of various system components in the described embodiments should also not be understood as requiring such separation in all embodiments, and it should be understood that the described program components and systems can generally be integrated together into a single software product or packaged into multiple software products.

Thus, particular embodiments of the subject matter have been described in this specification. In some cases, the actions recited herein can be performed in a different order and still achieve desirable results. Additionally, the processes depicted in the accompanying figures do not necessarily require the particular order shown, or any sequential order, to achieve desirable results. In some implementations, multitasking and parallel processing may be preferable or advantageous.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as Read Only Memory (ROM) devices and information alterably stored on writeable storage media such as floppy disks, magnetic tapes, Compact Discs (CDs), Random Access Memory (RAM) devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

The words used in the specification are words of description rather than limitation, and it is understood that various changes may be made without departing from the spirit and scope of the disclosure and claims.

As previously described, the features of various embodiments may be combined to form further embodiments that may not be explicitly described or illustrated. While various embodiments may have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A career management platform comprising:
one or more processors configured to, responsive to job postings specifying at least one deemphasized factor definition,
query a bank of platform users each having a value for a deemphasized factor and a value for one of a plurality of emphasized factors to generate pre-released datasets of candidate employees for the job postings according to a matching between the value for the deemphasized factor of each of the platform users and the at least one deemphasized factor definition,
responsive to detecting a trigger event, evaluate a factor frequency for each of the plurality of emphasized factors of the pre-released datasets of candidate employees,
responsive to the factor frequency for one of the plurality of emphasized factors being less than a threshold, altering a priority parameter for each of the platform users having the one of the plurality of emphasized factors such that the factor frequency for the one of the plurality of emphasized factors will increase for subsequent queries of the bank of platform users to increase occurrence of the platform users having the one of the plurality of emphasized factors in subsequent pre-released datasets of candidate employees resulting from the subsequent queries, and
outputting the pre-released datasets.

2. The career management platform of claim 1, wherein the trigger event is passage of a predetermined amount of time.

3. The career management platform of claim 1, wherein the trigger event is based on a comparison between the factor frequency and a predetermined frequency threshold.

4. The career management platform of claim 1, wherein the threshold is predetermined.

5. The career management platform of claim 1, wherein the threshold is based on another factor frequency for each of the plurality of emphasized factors of the bank of platform users.

6. A career management platform comprising:
one or more processors configured to, responsive to job postings specifying at least one deemphasized factor definition,
query a bank of platform users each having a value for a deemphasized factor and a value for one of a plurality of emphasized factors to generate pre-released datasets of candidate employees for the job postings according to a matching between the value for the deemphasized factor of each of the platform users and the at least one deemphasized factor definition,
responsive to detecting a trigger event, evaluate a factor frequency for each of the plurality of emphasized factors of the pre-released datasets of candidate employees,
responsive to the factor frequency for one of the plurality of emphasized factors being greater than a threshold, altering a priority parameter for each of the platform users having the one of the plurality of emphasized factors such that the factor frequency for the one of the plurality of emphasized factors will decrease for subsequent queries of the bank of platform users to decrease occurrence of the platform users having the one of the plurality of emphasized factors in subsequent pre-released datasets of candidate employees resulting from the subsequent queries, and
outputting the pre-released datasets.

7. The career management platform of claim 6, wherein the trigger event is passage of a predetermined amount of time.

8. The career management platform of claim 6, wherein the trigger event is based on a comparison between the factor frequency and a predetermined frequency threshold

9. The career management platform of claim 6, wherein the threshold is predetermined.

10. The career management platform of claim 6, wherein the threshold is based on another factor frequency for each of the plurality of emphasized factors of the bank of platform users.

11. A career management platform comprising:
one or more processors configured to, responsive to a query request from an employer,
query a bank of platform users each having a value for a deemphasized factor and a value for one of a plurality of emphasized factors,
generate a pre-released dataset of candidate employees according to a matching between the value of each of the platform users and at least one specified deemphasized factor definition,
calculate an amount of candidate employees with emphasized factors compared to an amount of total candidate employees contained in the pre-released dataset,
modify the pre-released dataset to create a modified dataset, and
output the modified dataset.

12. The career management platform of claim 11, wherein modifying the pre-released dataset includes again querying the bank of platform users with additional emphasized factors that were not included in the query, generating a second dataset with the additional emphasized factors, and introducing new candidates from the second dataset into the pre-released dataset to create the modified dataset.

13. The career management platform of claim 11, wherein modifying the pre-released dataset includes modifying parameters of the deemphasized factors, again querying the bank of platform users with the modified parameters of the deemphasized factors, generating a second dataset with the modified parameters of the deemphasized factors, and introducing new candidates from the second dataset into the pre-released dataset to create the modified dataset.

14. The career management platform of claim 13, wherein only candidate employees with emphasized factors in the second dataset are introduced into the pre-released dataset.

15. The career management platform of claim 13, wherein modifying the pre-released dataset may be repeated a predetermined number of iterations.
